(19) United States
(12) Patent Application Publication
(10) Pub. No.: US 2026/0172866 A1
(43) Pub. Date: Jun. 18, 2026

(54) OVERHEAD REDUCTION FOR CHANNEL CORRELATION REPORT

(71) Applicant: Google LLC, Mountain View, CA (US)

(72) Inventor: Yushu ZHANG, Beijing (CN)

(21) Appl. No.: 19/123,638

(22) PCT Filed: Nov. 4, 2022
(86) PCT No.: PCT/CN2022/130076

§ 371 Date: Apr. 23, 2025

(51) Int. Cl. H04W 24/10

(52) U.S. Cl. CPC H04W 24/10

(57) ABSTRACT

A UE (102) receives (508), from a network entity (104), a configuration for a measurement report. The measurement report corresponds to at least one of: a TDCC report using configured quantization parameters, a Doppler spread report, or a Doppler shift report that are each based on a measurement of one or TRSs. The UE (102) receives (350), from the network entity (104), the one or more TRSs and further receives (516) control signaling that triggers the configuration for the measurement report. The UE (102) transmits (520) the measurement report to the network entity (104) responsive to the receiving (516, 350) the control signaling and the one or more TRSs. The measurement report is generated based on the configuration.

### TECHNICAL FIELD

The present disclosure relates generally to wireless communication, and more particularly, to reducing an overhead for a time-domain channel correlation (TDCC) report and/or a Doppler spread/shift report.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture is designed to provide increased data rates, decreased latency, and/or increased capacity compared to other types of wireless communication systems.

Wireless communication systems, in general, are configured to provide various telecommunication services (e.g., telephony, video, data, messaging, broadcasts, etc.) based on any one of multiple-access technologies, such as orthogonal frequency division multiple access (OFDMA) technologies, that support communication with multiple UEs. Improvements in mobile broadband have been useful to continue the progression of such wireless communication technologies. For example, UE's movement relative to a base station can cause variation in a channel between the UE and the base station. However, reporting a channel correlation for the channel, which may have an increased number of delays, results in a high reporting overhead.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

Relative motion between communicating entities (e.g., a base station and a UE) causes a wireless channel used for the communication to vary. A UE may report, to the base station, information about a status of such a communication channel between the UE and the base station. For example, the UE transmits to a network entity, such as a base station or a radio unit (RU) of the base station, a TDCC report based on one or more tracking reference signals (TRSs) received from the network entity. The network entity is thus enabled to calculate a Doppler spread/shift based on the channel variations indicated in the TDCC report. In some examples, the UE performs equivalent calculations and transmits values of the Doppler spread/shift to the network entity. Because the channel correlation can be different at different delays, the channel correlation has to be reported for several delays. Repeated reports cause a high reporting overhead.

Methods and devices described hereinafter address the above-noted and other deficiencies by using quantization and/or compression techniques implemented at the UE for beam measurement and reporting procedures that reduce the overhead associated with multiple reporting of the channel correlation due to the different delays. The network entity may transmit downlink control signaling to the UE that indicates a set of quantization parameters for the TDCC report or the UE may independently determine the set of quantization parameters for the TDCC report. The TDCC report (e.g., quantized TDCC report) is formatted to reduce the reporting overhead, thereby improving the system performance for wireless communications between the network entity and the UE.

According to some aspects, the UE receives, from the network entity, a configuration for a measurement report. The measurement report corresponds to at least one of: a TDCC report using configured quantization parameters, a Doppler spread report, or a Doppler shift report that are each based on a measurement of the one or more TRSs. The UE receives, from the network entity, the one or more TRSs and further receives, from the network entity, control signaling that triggers applying the configuration for the measurement report. The UE transmits the measurement report to the network entity responsive to receiving the control signaling and the one or more TRSs. The UE generates the measurement report according to the received configuration.

According to some aspects, the network entity transmits, to the UE, the configuration for the measurement report, as described above. After the network entity transmits, to the UE, the one or more TRSs and the control signaling that triggers applying the configuration for generating the measurement report, the network entity receives, from the UE, the measurement report according to the configuration.

### BRIEF DESCRIPTION OF THE DRAWINGS

FIG. 1 illustrates a diagram of a wireless communications system that includes a plurality of UEs and network entities in communication over one or more cells.

FIG. 2 illustrates a diagram of an example slot structure for a tracking reference signal (TRS).

FIG. 3 is a signaling diagram that illustrates TDCC reporting on a per-TRS basis.

FIG. 4 is a signaling diagram that illustrates a cross-TRS TDCC reporting procedure for multiple TRSs.

FIG. 5 is a signaling diagram that illustrates a report content selection procedure.

FIG. 6 is a flowchart of a method of wireless communication at a UE.

FIG. 7 is a flowchart of a method of wireless communication at a network entity.

FIG. 8 is a diagram illustrating a hardware implementation for an example UE apparatus.

FIG. 9 is a diagram illustrating a hardware implementation for one or more example network entities.

### DETAILED DESCRIPTION

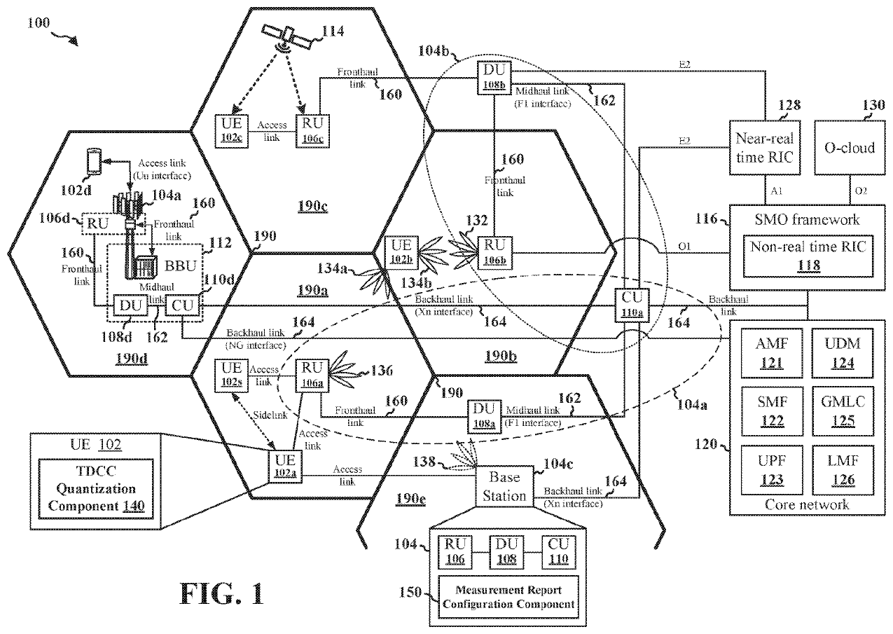

FIG. 1 illustrates a diagram of a wireless communications system 100 associated with a plurality 190 of cells 190a-c. The wireless communications system includes UEs 102a-d and base stations 104a-c, where some base stations (e.g., 104c) include an aggregated base station architecture and other base stations (e.g., 104a-104b) include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). A base station 104 and/or a unit of the base station 104, such as the RU 106, the DU 108, or the CU 110, may be referred to as a transmission reception point (TRP).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104c of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104c communicates with the CU 110a of the base station 104b over the backhaul link 164 based on the Xn interface. Similarly, the base station 104c of the cell 190e may communicate with the CU 110a of the base station 104b over a backhaul link 164 based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104c of the cell 190e via cross-cell communication beams of the RU 106a and the base station 104c.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or cross-cell communication beams. For example, the UE 102b of the cell 190b may communicate with the RU 106a of the cell 190a via a third set of communication beams 134a of the UE 102b and an RU beam set 136 of the RU 106a. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 118 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104c of cell 190d to transmit a downlink/forward link communication to the UE 102d or receive an uplink/reverse link communication from the UE 102d based on the Uu interface associated with the access link between the UE 102d and the base station 104c/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems. Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134b from the RU 106b in one or more receive directions of the UE 102b. In a further example, the UE 102b may also transmit an uplink beamformed signal to the RU 106b based on the second set of beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104c and a second base station 104b. For instance, the RU 106a of cell 190a may transmit a beamformed signal based on the RU beam set 136 to the base station 104c of cell 190e in one or more transmit directions of the RU 106a. The base station 104c of the cell 190e may receive the beamformed signal from the RU 106a based on a base station beam set 138 in one or more receive directions of the base station 104c. Similarly, the base station 104c of the cell 190e may transmit a beamformed signal to the RU 106a based on the base station beam set 138 in one or more transmit directions of the base station 104c. The RU 106a may receive the beamformed signal from the base station 104c of the cell 190e based on the RU beam set 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN). In some examples, the UE 102b operates in dual connectivity (DC) with the base station 104a and the base station 104b. In such cases, the base station 104a can be a master node and the base station 104b can be a secondary node. In other examples, the UE 102b operates in DC with the DU 108a and the DU 108b. In such cases, the DU 108a can be the master node and the DU 108b can be the secondary node.

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals. NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a TDCC quantization component 140 configured to receive, from a network entity, a configuration for a measurement report, the measurement report comprising at least one of: a TDCC report using configured quantization parameters, a Doppler spread report, or a Doppler shift report that are each based on a measurement of one or more TRSs; receive, from the network entity, the one or more TRSs; receive, from the network entity, control signaling that triggers the configuration for the measurement report; and transmit the measurement report to the network entity responsive to the receiving the control signaling and the one or more TRSs, the measurement report based on the configuration.

In certain aspects, the base station 104 or a network entity of the base station 104 may include a measurement report configuration component 150 configured to transmit, to a UE, a configuration for a measurement report, the measurement report comprising at least one of: a TDCC report using configured quantization parameters, a Doppler spread report, or a Doppler shift report that are each based on TRSs; transmit, to the UE, the one or more TRSs; transmit, to the UE, control signaling that triggers the configuration transmitted to the UE for the measurement report; and receive the measurement report from the UE in response to the transmitting the control signaling and the one or more TRSs, the measurement report based on the configuration.

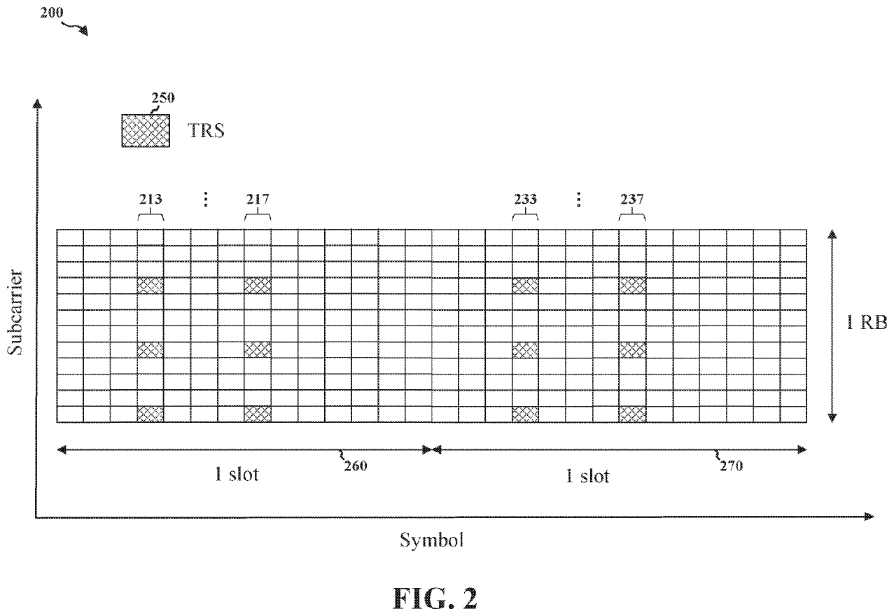

Accordingly, FIG. 1 describes a wireless communication system that may be implemented in connection with aspects of one or more other figures described herein, such as aspects illustrated in FIGS. 2-5. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 2 illustrates a diagram 200 of an example slot structure for TRS 250. The UE 102 and the network entity 104, such as a base station or a unit of a base station, might perform multiple-input multiple-output (MIMO) communications, where the network entity 104 can use channel state information (CSI) to select a digital precoder for the UE 102. The network entity 104 might configure CSI reporting from the UE 102 via RRC signaling (e.g., CSI-reportConfig), where the UE 102 may use a channel state information-reference signal (CSI-RS) as a channel measurement resource (CMR) for the UE 102 to measure a downlink channel. The TRS 250 corresponds to a special type of CSI-RS used for tracking. The network entity 104 may also configure (e.g., via the CSI-reportConfig) an interference measurement resource (IMR) for the UE 102 to measure interference to the downlink channel. Accordingly, the UE 102 may estimate a channel between the UE 102 and the network entity 104 based on the CSI-RS (e.g., TRS 250).

The network entity 104 may configure (e.g., based on the CSI-reportConfig) a time domain behavior, such as periodic, semi-persistent, or aperiodic reporting, for the transmission of the CSI report to the network entity 104. In examples, the network entity 104 may activate/deactivate a semi-persistent CSI report from the UE 102 using a MAC-control element (MAC-CE). The network entity 104 may trigger an aperiodic CSI report from the UE 102 based on transmission of downlink control information (DCI) to the UE 102. The network entity 104 may receive a periodic CSI report from the UE 102 on physical uplink control channel (PUCCH) resources (e.g., configured via the CSI-reportConfig). The CSI-reportConfig may also be used to configure PUCCH resources for transmission of the semi-persistent CSI report to the network entity 104. In other examples, transmission of the semi-persistent CSI report to the network entity 104 may be on physical uplink shared channel (PUSCH) resources triggered by the DCI. The UE 102 may likewise transmit the aperiodic CSI report on the PUSCH resources triggered by the DCI.

When reporting the CSI on PUSCH or PUCCH in a long format (e.g., long PUCCH), the UE 102 can divide the CSI into two parts: CSI part 1 and CSI part 2. CSI part 1 is based on a fixed payload size according to an RRC configuration, which may include a CSI-RS resource indicator (CRI), a rank indicator (RI), and/or a channel quality indicator (CQI) for a first codeword. The UE 102 can determine the payload size for the CSI part 2 based on report content for the CSI part 1. The CSI part 2 may include a precoder matrix indicator (PMI), CQI for a second codeword, and/or a layer indicator (LI).

The UE 102 might measure a channel state information-reference signal (CSI-RS) for tracking (e.g., the TRS 250), to perform time and frequency offset tracking. The time and frequency offset tracking can include Doppler shift and Doppler spread estimations. The TRS 250 might correspond to a CSI-RS resource set associated with a configured RRC parameter (e.g., trs-Info). The network entity 104 can transmit control signaling, such as RRC signaling, to configure a periodic TRS 250 (e.g., via a non-zero power (NZP)-CSI-RS-ResourceSet configured with higher layer parameter trs-Info) or trigger an aperiodic TRS via downlink control information (DCI).

In examples, the network entity 104 may configure a downlink reference signal, such as the TRS 250, to be transmitted in two symbols of a slot (e.g., symbol 3 of resource 213 and symbol 7 of resource 217 of a first slot 260) or in four symbols distributed across two consecutive slots (e.g., symbol 3 of resource 213 and symbol 7 of resource 217 of the first slot 260 and symbol 3 of resource 233 and symbol 7 of resource 237 of a second slot 270), where two CSI-RS resources or four CSI-RS resources may be associated with the NZP-CSI-RS-ResourceSet configured with the higher layer parameter trs-Info. The diagram 200 illustrates an example of a 2-slot based (e.g., 4-resource based) TRS structure distributed over a resource block (RB) (e.g., 12 subcarriers). A 1-slot based (e.g., 2-resource based) TRS structure may correspond to a subset of the 2-slot structure. For example, the 1-slot based TRS structure may correspond to the first slot 260.

The aperiodic TRS might be quasi-co-located (QCLed) with the periodic TRS 250, such that the network entity 104 can provide a QCL indication to the UE 102 through DCL. The network entity 104 may configure a QCL type and/or a source reference signal for the QCL signaling. QCL types for downlink reference signals might be based on a higher layer parameter, such a qcl-Type in a QCL-Info parameter. A first QCL type that corresponds to typeA might be associated with a Doppler shift, a Doppler spread, an average delay, and/or a delay spread. A second QCL type that corresponds to typeB might be associated with the Doppler shift and/or the Doppler spread. A third QCL type that corresponds to typeC might be associated with the Doppler shift and/or the average delay. A fourth QCL type that corresponds to typeD might be associated with a spatial receive (Rx) parameter.

Movement of the UE 102 can cause a wireless channel between the UE 102 and the network entity 104 to vary. The UE 102 may report, to the network entity 104, information about a status of the channel between the UE 102 and the network entity 104. For example, the UE 102 can transmit a TDCC report to the network entity 104 based on one or more TRSs 250 received from the network entity 104. The network entity 104 can calculate the Doppler spread f_{d}(τ) for a time-domain channel at delay r using the channel correlation between symbol i and symbol j based on:

$$E \{ {r}_{i , j} ( τ ) \} = {J}_{0} ( 2 π {f}_{d} ( τ ) ( j - i ) γ )$$

where γ is a time-domain duration for a symbol. J₀( ) is a zero-order Bessel function, r_{i,j}(τ) is a normalized channel correlation matrix, which is determined based on:

$${r}_{i , j} ( τ ) = \frac{{h}_{i} ( τ ) {h}_{j}^{*} ( τ )}{\vert {h}_{i} ( τ ) \vert \vert {h}_{j} ( τ ) \vert}$$

where hᵢ(T) indicates the time-domain channel for symbol i at delay τ.

For a channel correlation matrix that is measured using periodic downlink reference signals (e.g., TRSs 250), the channel correlation matrix may be averaged across multiple slots based on:

$${r}_{i , j} ( τ ) = \frac{1}{N} {\sum }_{k = 1}^{N} \frac{{h}_{i} ( τ , {s}_{k} ) {h}_{j}^{*} ( τ , {s}_{k} )}{\vert {h}_{i} ( τ , {s}_{k} ) \vert \vert {h}_{j} ( τ , {s}_{k} ) \vert}$$

where hᵢ(τ,sₖ) indicates the time-domain channel for symbol i at delay τ in slot sₖ. The channel correlation can also be calculated to include interference and noise suppression based on:

$${r}_{i , j} ( τ ) = \frac{1}{N} {\sum }_{k = 1}^{N} \frac{{h}_{i} ( τ , {s}_{k} ) {h}_{j}^{*} ( τ , {s}_{k} ) - {σ}^{2}}{\vert {h}_{i} ( τ , {s}_{k} ) \vert \vert {h}_{j} ( τ , {s}_{k} ) \vert - {σ}^{2}}$$

where σ² indicates the interference and noise power within an estimated channel. The network entity 104 can calculate a Doppler spread/shift based on the channel variations indicated in the TDCC report. In some examples, the UE 102 might perform equivalent calculations and transmit values of the Doppler spread/shift to the network entity 104.

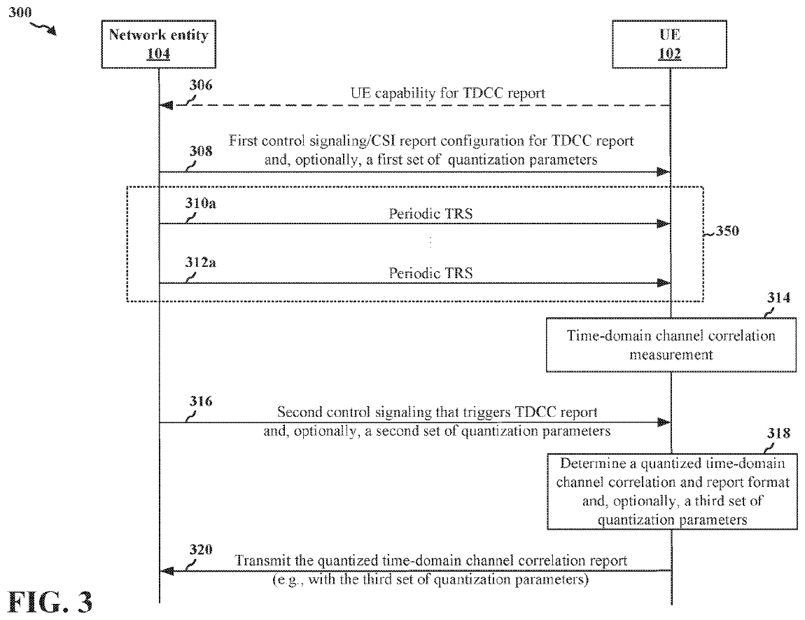

Because the channel correlation is likely different at different delays, reporting the channel correlation for several delays becomes necessary. This repeated reporting results in a high reporting overhead. Hence, quantization and/or compression techniques are implemented at the UE 102 for beam measurement and reporting procedures to reduce the overhead associated with reporting the channel correlation for the different delays. The network entity 104 may transmit downlink control signaling to the UE 102 that indicates a set of quantization parameters for the TDCC report or the UE 102 may independently determine the set of quantization parameters for the TDCC report. A format of the TDCC report (e.g., a quantized TDCC report) reduces the reporting overhead, thereby improving system performance for wireless communications between the UE 102 and the network entity 104. FIGS. 3-5 describe techniques for report formatting to report a quality of a channel.

FIG. 3 is a signaling diagram 300 that illustrates TDCC reporting on a per-TRS basis (e.g., based on per-TRS transmission procedure 350). The UE 102 may transmit 306 a UE capability report that indicates one or more UE capabilities for TDCC reporting to the network entity 104. For example, the UE 102 can indicate, to the network entity 104, a capability of the UE 102 to report the TDCC for each TRS (e.g., per-TRS TDCC reporting). The one or more UE capabilities might indicate whether the UE 102 supports TDCC measurements, a first maximum number of serving cells for the TDCC report, and/or a second maximum number of channel paths for the TDCC report. That is, the UE 102 might indicate a first maximum number of taps to report for the TDCC report and a second maximum number of TRS in a serving cell or across serving cells for the TDCC report. The TDCC corresponds to the channel correlation at different delays. One tap indicates one delay. Different taps indicate the TDCC calculated from the different delays τ. The second maximum number of TRS may be counted per CC, per band, per band combination, and/or per UE. In other implementations, the network entity 104 may receive the one or more UE capabilities from a core network entity, such as the AMF 121 illustrated in the diagram 100.

The network entity 104 transmits 308, to the UE 102, first control signaling including a CSI report configuration that configures the UE 102 for TDCC reporting. The first control signaling/configuration for the TDCC report may correspond to RRC signaling (e.g., a CSI-ReportConfig in an RRCReconfiguration). The RRC signaling may indicate a RRC reconfiguration message from the network entity 104 to the UE 102, or a system information block (SIB), where the SIB can be a predefined SIB (e.g., SIB1) or a different SIB (e.g., SIB J, where J is an integer above 21) transmitted by the network entity 104. In examples, the CSI report configuration is based on the one or more UE capabilities that the network entity 104 receives 306 from the UE 102.

The first control signaling can optionally include a first set of quantization parameters. For example, the network entity 104 can transmit 308, in the first control signaling, quantization parameters such as a maximum number of measured taps

$${N}_{tap}^{max}$$

(e.g., non-zero coefficients (NZC) for the TDCC report), a maximum number of reported taps

$${K}_{tap}^{max}$$

(e.g., maximum number of reported NZCs for the TDCC report), a number of reported taps Kₜₐₚ (e.g., number of reported NZCs for the TDCC report), a time-domain duration for each tap Tₜₐₚ, a number of bits for a quantized NZC, one or more symbol offsets for the TDCC report, etc.

For 2-slot TDCC reporting, as illustrated in the diagram 200, candidate symbol offsets may be {4, 14, 18}. In other examples, the network entity 104 may configure the UE 102 to report an intra-slot TDCC (e.g., with a 4 symbol offset) or inter-slot TDCC (with a 14 and/or 18 symbol offset) or both. Quantized content, such as amplitude-only reporting or both amplitude and phase reporting, may be associated with each NZC. If the network entity 104 does not configure a complete set of quantization parameters, or any quantization parameters, in the first control signaling, the network entity 104 can include a set of quantization parameters in the second control signaling transmitted 316 to the UE 102 that triggers the TDCC report. If the network entity 104 does include at least one quantization parameter in the first control signaling, the network entity 104 may not include any quantization parameters in the second control signaling transmitted 316 to the UE 102 that triggers the TDCC report.

The network entity 104 transmits 310a, 312a periodic TRS to the UE 102. The UE 102 can perform 314 a TDCC measurement for the TDCC report in response to receiving 310a, 312a the periodic TRS from the network entity 104. The network entity 104 transmits 316 the second control signaling to the UE 102 to trigger the TDCC report. The UE 102 determines a quantized TDCC and a report format for the quantized TDCC (e.g., based on the first/second set of quantization parameters). In cases where neither the first control signaling nor the second control signaling include a set of quantization parameters, the UE 102 can optionally determine 318 a third set of quantization parameters for quantization of the TDCC report. The UE 102 can report the third set of quantization parameters to the network entity 104 in the quantized TDCC report that the UE 102 transmits 320 to the network entity 104.

If the network entity 104 does not configure any quantization parameters to the UE 102, the network entity 104 and the UE 102 may apply default values for quantization parameters. The default values may correspond to a maximum number of measured taps being based on a length of a cyclic prefix (CP) T_{CP} and a duration for each tap Tₜₐₚ, e.g.

$$ceil ( \frac{{T}_{CP}}{{T}_{tap}} ) ,$$

a maximum number of reported taps being the same as the maximum number of measured taps, a number of reported taps being the same as the maximum number of reported taps, a time-domain duration for each tap being based on the symbol duration T_{sym} and a number of resource elements in a TRS symbol for the TDCC measurement 314 N_{RE}, e.g.,

$$\frac{{T}_{sym}}{{N}_{RE}} ,$$

a number of bits for a quantized NZC being equal to 3, the symbol offsets for the TDCC report being equal to 4 and 14, or quantized content for each NZC being based on an amplitude of the NZC. In some implementations, the UE 102 may perform 314 a TDCC measurement based on one receiving antenna port. The receiving antenna port may correspond to a highest or lowest measured layer-1 reference signal receiving power (L1-RSRP) or layer-1 signal-to-interference plus noise ratio (LI-SINR) among all the receiving antenna ports. In some other implementations, the UE 102 may perform 314 a TDCC measurement based on more than one receiving antenna ports, and the UE 102 may quantize and report one TDCC based on the measured TDCCs from the receiving antenna ports. The one TDCC may be an average, a minimum, or a maximum TDCC of the measured TDCCs. In some other implementations, the UE 102 may perform 314 a TDCC measurement based on more than one receiving antenna ports, and the UE 102 may quantize and report based on the measured TDCCs from the receiving antenna ports.

After receiving 308, 316 the first/second control signaling, the UE 102 may quantize the TDCC measurement 314 based on the set(s) of quantization parameters. If the UE 102 determines a third set of quantization parameters, the UE 102 may quantize the TDCC measurement 314 based on the received 308, 316 first/second set(s) of quantization parameters and/or the determined 318 third set of quantization parameters. The UE 102 transmits 320 the quantized TDCC report to the network entity 104 based on the determined 318 quantization and report format, where the report format indicates information reported in CSI part 1 and CSI part 2. The TDCC report may indicate the third set of quantization parameters to the network entity 104 when the TDCC report is based on the third set of quantitation parameters. The third quantization parameter(s) set may be reported in CSI part 1 or CSI part 2.

The UE 102 can measure 314 the TDCC according to the maximum number of measured taps

$${N}_{tap}^{max}$$

based on:

$${\tilde{r}}_{i , j} = [ {r}_{i , j} ( 0 ) , {r}_{i , j} ( {T}_{tap} ) , … , {r}_{i , j} ( ( {N}_{tap}^{max} - 1 ) {T}_{tap} ) ] .$$

where r corresponds to the channel correlation, i corresponds to symbol i, and j corresponds to symbol j. The UE 102 may report the maximum number of measured taps in the TDCC report transmitted 320 to the network entity. In examples, the UE 102 can report a first

$${K}_{tap}^{max}$$

taps, where the reported taps are based on:

$${s}_{i , j} = [ {\tilde{r}}_{i , j} ( 1 ) , {\tilde{r}}_{i , j} ( 2 ) , … , {\tilde{r}}_{i , j} ( {K}_{tap}^{max} ) ] .$$

The UE 102 may report the

$${K}_{tap}^{max}$$

coefficients in CSI part 1 or CSI part 2. For coefficient k, the UE 102 may report the quantized amplitude for s_{i,j}(k). Alternatively, for coefficient k, the UE 102 may report the quantized amplitude and phase for s_{i,j}(k). The UE 102 may quantize the amplitude based on a predefined quantization procedure and a configured or predefined number of quantized bits for the amplitude.

In a first example, the amplitude can be quantized based on a 3-bit quantization procedure, where reported bits [000, 001, 010, 011, 100, 101, 110, 110] respectively correspond to amplitudes [0, 1/\sqrt{6}4, 1/\sqrt{3}2, 1/\sqrt{1}6, 1/\sqrt{8}, 1/\sqrt{4}, 1/\sqrt{2}, 1]. In a second example, the amplitude can be quantized based on another 3-bit quantization procedure, where the reported bits [000, 001, 010, 011, 100, 101, 110, 110] respectively correspond to amplitudes [0, 1/\sqrt{7}, 2/\sqrt{7}, 3/\sqrt{7}, 4/\sqrt{7}, 5/\sqrt{7}, 6/\sqrt{7}, 1]. The UE 102 can quantizes the phase based on a predefined quantization procedure and a configured or predefined number of quantized bits. For example, the phase can be quantized based on a 3-bit quantization procedure, where the reported bits [000, 001, 010, 011, 100, 101, 110, 110] respectively correspond to phases [0, 2π/7, 4π/7, 6π/7, 8π/7, 10π/7, 12π/7, 2π].

If the UE 102 reports the TDCC for more than 1 symbol offset, the UE 102 may report the

$${K}_{tap}^{max}$$

coefficients for each symbol offset. In examples, the UE reports the first Kₜₐₚ taps for each symbol offset based on:

$${s}_{i , j} = [ {\tilde{r}}_{i , j} ( 1 ) , {\tilde{r}}_{i , j} ( 2 ) , … , {\tilde{r}}_{i , j} ( {K}_{tap} ) ] .$$

The UE 102 may report the Kₜₐₚ coefficients in CSI part 1 or CSI part 2. The UE 102 may also report a value of the Kₜₐₚ in the CSI part 1 or the CSI part 2. In examples, the UE 102 may report the value of Kₜₐₚ in CSI part 1 and the UE 102 may report Kₜₐₚ coefficients in CSI part 2. A payload size for the TDCC report in the CSI part 2 may be based on the reported value of Kₜₐₚ in the CSI part 1. If the UE 102 reports the TDCC for more than 1 symbol offset, the UE 102 may report the Kₜₐₚ coefficients and value of Kₜₐₚ for each symbol offset. The UE 102 may report the Kₜₐₚ coefficients for each symbol offset and a common value of Kₜₐₚ for all symbols offsets.

For each symbol offset, the UE 102 may report a first

$${K}_{tap}^{max}$$

taps after a tap with a strongest power based on:

$${s}_{i , j} = [ {\tilde{r}}_{i , j} ( {k}_{max} ) , {\tilde{r}}_{i , j} ( ( {k}_{max} + 1 ) mod {K}_{tap}^{max} ) , … , \\ {\tilde{r}}_{i , j} ( ( {k}_{max} + {K}_{tap}^{max} - 1 ) mod {K}_{tap}^{max} ) ]$$

where kₘₐₓ is the index of the strongest tap. Alternatively, the UE 102 may report the

$$\frac{{K}_{tap}^{max}}{2} - 1$$

taps before the strongest tap and the

$$\frac{{K}_{tap}^{max}}{2}$$

taps after the strongest tap. In examples, the reported coefficients are based on:

$${s}_{i , j} = [ {\tilde{r}}_{i , j} ( ( {k}_{max} - \frac{{K}_{tap}^{max}}{2} + 1 ) mod {K}_{tap}^{max} , … , {\tilde{r}}_{i , j} ( {k}_{max} ) , \\ {\tilde{r}}_{i , j} ( ( {k}_{max} + 1 ) mod {K}_{tap}^{max} ) , … , {\tilde{r}}_{i , j} ( ( {k}_{max} + \frac{{K}_{tap}^{max}}{2} ) mod {K}_{tap}^{max} ) ] .$$

The UE 102 reports the

$${K}_{tap}^{max}$$

coefficients and the value of kₘₐₓ in CSI part 1 or CSI part 2. In examples, the UE 102 may report the value of kₘₐₓ and the

$${K}_{tap}^{max}$$

coefficients in the same CSI part. The UE 102 may report the

$${K}_{tap}^{max}$$

coefficients and the value of kₘₐₓ for each symbol offset when the UE 102 reports the TDCC for more than 1 symbol offset. The UE 102 may report the

$${K}_{tap}^{max}$$

coefficients for each symbol offset and a common value of kₘₐₓ for all symbol offsets.

The UE 102 may report, for each symbol offset, the first Kₜₐₚ taps after the tap with the strongest power based on:

$${s}_{i , j} = [ {\tilde{r}}_{i , j} ( {k}_{max} ) , {\tilde{r}}_{i , j} ( ( {k}_{max} + 1 ) mod {K}_{tap}^{max} ) , … , {\tilde{r}}_{i , j} ( ( {k}_{max} + {K}_{tap} - 1 ) mod {K}_{tap}^{max} ) ]$$

where kₘₐₓ is the index of the strongest tap. Alternatively, the UE 102 may report the

$$\frac{{K}_{tap}}{2} - 1$$

taps before the strongest tap and the

$$\frac{{K}_{tap}}{2}$$

taps after the strongest tap. In examples, the reported coefficients are based on:

$${s}_{i , j} = [ {\tilde{r}}_{i , j} ( ( {k}_{max} - \frac{{K}_{tap}}{2} + 1 ) mod {K}_{tap}^{max} , … , {\tilde{r}}_{i , j} ( {k}_{max} ) , {\tilde{r}}_{i , j} ( ( {k}_{max} + 1 ) mod {K}_{tap}^{max} ) , … , {\tilde{r}}_{i , j} ( ( {k}_{max} + \frac{{K}_{tap}}{2} ) mod {K}_{tap}^{max} ) ] .$$

The UE 102 reports the Kₜₐₚ coefficients, the value of kₘₐₓ, and the value of Kₜₐₚ in CSI part 1 or CSI part 2. In examples, the UE 102 reports the value of Kₜₐₚ in CSI part 1 and reports the value of kₘₐₓ and the

$${K}_{tap}^{max}$$

coefficients in CSI part 2.

The UE 102 may report the Kₜₐₚ coefficients, the value of Kₜₐₚ, and the value of kₘₐₓ for each symbol offset when the UE 102 reports the TDCC for more than 1 symbol offset. The UE 102 may report the Kₜₐₚ coefficients for each symbol offset, a common value of km, and a common value of Kₜₐₚ for all symbol offsets. The UE 102 may report the Kₜₐₚ coefficients and the value of kₘₐₓ for each symbol offset and a common value of Kₜₐₚ for all symbol offsets. In further examples, the UE 102 reports the Kₜₐₚ coefficients and the value of Kₜₐₚ for each symbol offset and a common value of kₘₐₓ for all symbols offsets.

The UE 102 may report the strongest Kₜₐₚ taps for each symbol offset. The UE 102 may report a first vector to indicate the index of the reported Kₜₐₚ taps within the

$${K}_{tap}^{max}$$

taps and a second vector to indicate the coefficient for the reported Kₜₐₚ taps. The first vector may be a bitmap with

$${K}_{tap}^{max} bits ,$$

where value 0 indicates that the tap is not reported and value 1 indicate that the tap is reported.

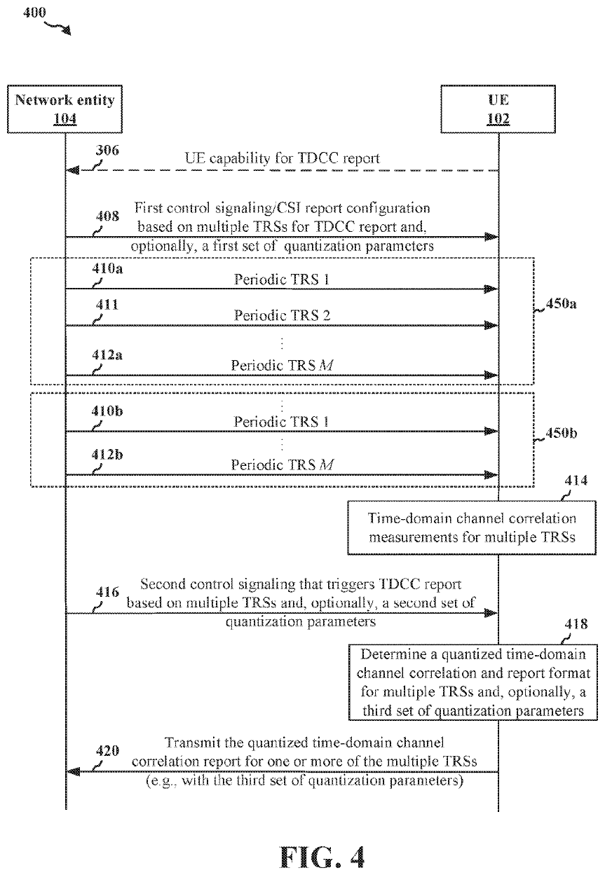

The UE 102 may report the first vector in CSI part 1 or CSI part 2. The UE 102 may similarly report the second vector in CSI part 1 or CSI part 2. In an example, the UE 102 reports the first vector in CSI part 1 and the second vector in CSI part 2. The payload size of the second vector is based on the number of “1” values in the reported first vector. The UE 102 may report the first and the second vectors for each symbol offset when the UE 102 reports the TDCC for more than 1 symbol offset. The UE 102 may report the second vector for each symbol offset and a common first vector for all symbols offsets. FIG. 3 describes per-TRS TDCC reporting, whereas FIG. 4 describes cross-TRS TDCC reporting.

FIG. 4 is a signaling diagram 400 that illustrates a cross-TRS TDCC reporting procedure for multiple TRSs (e.g., based on cross-TRS transmission procedures 450a-450b). Element 306 has already been described with respect to FIG. 3.

The network entity 104 transmits 408 first control signaling including a CSI reporting configuration that configures the UE 102 to measure 414 the TDCC for multiple TRSs for the TDCC report. The first control signaling may include quantization parameters for the UE 102 to report the TDCC for more than one TRS. The UE 102 receives 410a-412b the multiple TRSs from the network entity 104 for cross-TRS TDCC reporting. For example, the UE 102 may receive 410a, 411, 412a a periodic TRS 1, a periodic TRS 2, through a periodic TRS M during a first cross-TRS transmission procedure 450a. The UE 102 may again receive 410b, 412b the periodic TRS 1 through the periodic TRS M during a second cross-TRS transmission procedure 450b. The UE 102 may select a subset of the TRSs for the TDCC report based on the TDCC measurements 414 for the multiple TRSs. The UE 102 may report the TDCC based on joint quantization of the TRSs when the UE 102 reports the TDCC for more than one TRS.

A first set of quantization parameters indicated in the first control signaling may include a maximum number of measured taps

$${K}_{tap}^{max}$$

(e.g. NZC for TDCC report for each TRS, where the network entity 104 may configure a common parameter or separate parameters per TRS), a maximum number of reported taps

$${K}_{tap}^{max}$$

(e.g., maximum number of reported NZC for the TDCC report for each TRS, where the network entity may configure a common parameter or separate parameters per TRS), a maximum total number of reported taps

$${K}_{tap , sum}^{max}$$

(e.g., a maximum total number of reported NZC for the TDCC report across the TRSs), a number of reported taps Kₜₐₚ (e.g., a number of reported NZC for the TDCC report for each TRS, where the network entity 104 may configure a common parameter or separate parameters per TRS), a total number of reported taps K_{tap,sum} (e.g., a number of reported NZC for the TDCC report across TRSs), a time-domain duration for each tap Tₜₐₚ for each TRS where the network entity 104 may configure a common parameter or separate parameters per TRS, a number of bits for a quantized NZC for each TRS where the network entity 104 may configure a common parameter or separate parameters per TRS, one or more symbol offsets for the TDCC report that indicate the symbol offsets for the two symbols for the TDCC report for each TRS where the network entity 104 may configure a common parameter or separate parameters per TRS, quantized content for each NZC (e.g., whether to report amplitude-only or both amplitude and phase for the TDCC report for each TRS) where the network entity may configure a common parameter or separate parameters per TRS, and/or a number of reported TDCCs N_{TDCC}.

If the network entity 104 does not configure a complete set of quantization parameters, or any quantization parameters, via the first control signaling, the network entity 104 may transmit 416 second control signaling that indicates quantization parameters (e.g., a second set of quantization parameters). In other examples, the second control signaling may not indicate any quantization parameters, such as when the first control signaling indicates at least one quantization parameter in a first set of quantization parameters. The network transmits 416 the second control signaling to trigger the TDCC report based on the multiple TRSs.

In cases where the network entity 104 does not configure any quantization parameters in the first/second control signaling, the UE 102 may determine 418 a third set of quantization parameters and reports the third set of quantization parameters to the network entity 104. For example, the UE 102 determines 418 a quantized TDCC report and report format for the multiple TRSs and, optionally, determines 418 the third set of quantization parameters, such that the UE 102 may transmit 420 the quantized TDCC report for one or more of the multiple TRSs (e.g., with the third set of quantization parameters indicated in the TDCC report). The third set of quantization parameters may include parameters for cross-TRS TDCC quantization. The third set of quantization parameters may be common or separate parameters for each reported TDCC.

In other implementations, if the network entity does not configure any quantization parameters in the first/second control signaling, the UE 102 and the network entity 104 may apply default values for the quantization parameters. The default values may include a maximum number of measured taps for the TDCC report per TRS being based on the length of the CP T_{CP} and the duration for each tap Tₜₐₚ, e.g.

$$ceil ( \frac{{T}_{CP}}{{T}_{tap}} ) ,$$

a maximum number of reported taps for the TDCC report per TRS being the same as the maximum number of measured taps, a maximum total number of reported taps for the TDCC report across TRSs being the same as the maximum number of measured taps multiplied by a number of reported TDCCs, a number of reported taps for the TDCC report per TRS being the same as the maximum number of reported taps for TDCC report per TRS, a number of reported taps for the TDCC report across TRSs being the same as the maximum number of reported taps for the TDCC report across TRSs, and/or a time-domain duration for each tap for the TDCC report per TRS being based on the symbol duration T_{sym} and number of resource elements in a the TRS symbol for TDCC measurement NR, e.g.

$$\frac{{T}_{sym}}{{N}_{RE}} .$$

In some implementations, the network entity 104 may transmit 410a-412b the TRSs for the TDCC report with the same bandwidth (e.g., the network entity 104 may refrain from transmitting 410a-412b the TRSs for the TDCC report with different bandwidths). The default values may further include a number of bits for a quantized NZC for the TDCC report per TRS being equal to 3, symbol offsets for the TDCC report per TRS being equal to 4 and 14, quantized content for each NZC for the TDCC report per TRS being based on an amplitude of the NZC, and/or a number of reported TDCCs being the same as the number of TRSs configured for the TDCC report.

The UE 102 quantizes the TDCC measurement 414 based on the quantization parameters after receiving 408, 416 the first/second control signaling from the network entity 104. The UE 102 may determine 418 the third set of quantization parameters and quantize the measured TDCC based on the third set of quantization parameters, or the UE 102 may quantize the measured TDCC based on the first/second set(s) of quantization parameters received 408, 416 in the first/second control signaling. The UE 102 transmits 420 the quantized TDCC report to the network entity 104 for one or more of the multiple TRSs. In some examples, the quantized TDCC report may include the third set of quantization parameters, which may be reported in either CSI part 1 or CSI part 2.

To measure, quantize, and report the TDCC for the multiple TRSs, the UE 102 can optionally select a subset of TRSs from the configured TRSs for TDCC measurement 414 and reporting 420. In some implementation, the UE 102 performs the selection based on an L1-RSRP/LI-SINR measured 414 from the TRSs. The UE 102 selects the N_{TDCC} TRSs with the highest L1-RSRP/L1-SINR and measures 414 the TDCC for the selected TRSs. The UE 102 may jointly or separately quantize the TDCCs for the TDCC report. The UE 102 determines 418 the report format and content for the quantized coefficients and transmits 420 the TDCC report to the network entity 104.

For each symbol offset for TRS x, the UE 102 reports the first K_{tap,x} taps, where the reported taps are based on:

$${s}_{i , j} = [ {\tilde{r}}_{i , j} ( 1 ) , {\tilde{r}}_{i , j} ( 2 ) , … , {\tilde{r}}_{i , j} ( {K}_{tap , x} ) ] .$$

The UE 102 reports the

$$X {\sum }_{x = 1}^{X} {K}_{tap , x}$$

coefficients in CSI part 1 or CSI part 2. The UE 102 may report the value of K_{tap,x} in the CSI part 1 or the CSI part 2. The value of K_{tap,x} may be the same for the X TRSs (e.g., K_{tap,x}=Kₜₐₚ). The UE 102 reports 1 value for Kₜₐₚ and

$$X {\sum }_{x = 1}^{X} {K}_{tap , x}$$

coefficients for X TDCCs. In examples, the UE 102 reports the value of Kₜₐₚ in CSI part 1 and reports

$$X {\sum }_{x = 1}^{X} {K}_{tap , x}$$

coefficients in CSI part 2. The payload size for the TDCC report in CSI part 2 is based on the reported value of Kₜₐₚ in CSI part 1. The value of K_{tap,x} can be different for each TRSs. The UE 102 may report all values of K_{tap,x} and

$$X {\sum }_{x = 1}^{X} {K}_{tap , x}$$

coefficients for the X TDCCs. In examples, the UE 102 reports the X value of Kₜₐₚ in the CSI part 1 and reports the

$$X {\sum }_{x = 1}^{X} {K}_{tap , x}$$

coefficients in the CSI part 2. The payload size for the TDCC report in the CSI part 2 is based on the reported value of K_{tap,x} in the CSI part 1. The UE 102 may also report selected TRS indexes in CSI part 1 or CSI part 2.

The UE 102 may report the

$$X {\sum }_{x = 1}^{X} {K}_{tap , x}$$

x coefficients and the value of Kₜₐₚ or the values of each K_{tap,x} for each symbol offset when the UE 102 reports the TDCC for more than 1 symbol offset. The UE 102 may report the

$$X {\sum }_{x = 1}^{X} {K}_{tap , x}$$

coefficients for each symbol offset and a common value of Kₜₐₚ or common values of each K_{tap,x} for the symbol offsets.

For each symbol offset for TRS x, the UE 102 may report the first

$${K}_{tap}^{max}$$

taps after the tap with the strongest power based on:

$${s}_{i , j} = [ {\tilde{r}}_{i , j} ( {k}_{max , x} ) , {\tilde{r}}_{i , j} ( ( {k}_{max , x} + 1 ) mod {K}_{tap}^{max} ) , … , \\ {\tilde{r}}_{i , j} ( ( {k}_{max , x} + {K}_{tap}^{max} - 1 ) mod {K}_{tap}^{max} ) ]$$

where k_{max,x} is the index of the strongest tap for TRS x. Alternatively, the UE 102 may report the

$$\frac{{K}_{tap}^{max}}{2} - 1$$

taps before the strongest tap and the

$$\frac{{K}_{tap}^{max}}{2}$$

taps after the strongest tap. In examples, the reported coefficients are based on:

$${s}_{i , j} = [ {\tilde{r}}_{i , j} ( ( {k}_{max , x} - \frac{{K}_{tap}^{max}}{2} + 1 ) mod {K}_{tap}^{max} , … , {\tilde{r}}_{i , j} ( {k}_{max , x} ) , \\ {\tilde{r}}_{i , j} ( ( {k}_{max} + 1 ) mod {K}_{tap}^{max} ) , … , {\tilde{r}}_{i , j} ( ( {k}_{max , x} + \frac{{K}_{tap}^{max}}{2} ) mod {K}_{tap}^{max} ) ] .$$

The UE 102 reports the

$${XK}_{tap}^{max}$$

coefficients in the CSI part 1 or the CSI part 2 for the X selected TRSs. The UE 102 reports the value of k_{max,x} in the CSI part 1 or the CSI part 2. The UE 102 may report a common value of k_{max,x} for the selected TRSs (e.g., k_{max,x}=k_{max,x}_{₀}), where x0 indicates the TRS with the strongest L1-RSRP/L1-SINR. In other implementations, the UE 102 may report separate values of k_{max,x} for each TRS. The UE 102 may report the value of k_{max,x}_{₀}, or X values of k_{max,x} and the

$${XK}_{tap}^{max}$$

coefficients in the same CSI part. The UE 102 may also report the selected TRS indexes in the CSI part 1 or the CSI part 2. The UE 102 may report the

$${XK}_{tap}^{max}$$

coefficients and the value of k_{max,x}_{₀} or the X values of k_{max,x} for each symbol offset when the UE 102 reports the TDCC for more than 1 symbol offset. In other implementations, the UE 102 may report the

$${XK}_{tap}^{max}$$

coefficients for each symbol offset and a common value of k_{max,x}_{₀} or X common values of k_{max,x} for the symbol offsets.

For each symbol offset for TRS x, the UE 102 may report the first K_{tap,x} taps after the tap with the strongest power based on:

$${s}_{i , j} = [ {\tilde{r}}_{i , j} ( {k}_{max , x} ) , {\tilde{r}}_{i , j} ( ( k - max , x + 1 ) mod {K}_{tap}^{max} ) , \text{} … , {\tilde{r}}_{i , j} ( ( {k}_{max , x} + {K}_{tap , x} - 1 ) mod {K}_{tap}^{max} ) ] .$$

where kₘₐₓ. x is the index of the strongest tap for TRS x. Alternatively, the UE 102 may report the

$$\frac{{K}_{tap , x}}{2} - 1$$

taps before the strongest tap and the

$$\frac{{K}_{tap , x}}{2}$$

taps after the strongest tap. In examples, the reported coefficients are based on:

$${s}_{i , j} = [ {\tilde{r}}_{i , j} ( ( {k}_{max , x} - \frac{{K}_{tap , x}}{2} + 1 ) mod {K}_{tap}^{max} , … , {\tilde{r}}_{i , j} ( {k}_{max , x} ) , \text{} {\tilde{r}}_{i , j} ( ( {k}_{max , x} + 1 ) mod {K}_{tap}^{max} ) , … , {\tilde{r}}_{i , j} ( ( {k}_{max , x} + \frac{{K}_{tap , x}}{2} ) mod {K}_{tap}^{max} ) ] .$$

The UE 102 reports the

$$X {\sum }_{x = 1}^{X} {K}_{tap , x}$$

coefficients for the X selected TRSs in CSI part 1 or CSI part 2. The UE 102 reports the value of k_{max,x} in the CSI part 1 or the CSI part 2. In some implementations, the UE 102 reports a common value of k_{max,x} for all the selected TRSs (e.g., k_{max,x}=k_{max,x}), where x0 indicates the TRS with the strongest L1-RSRP/L1-SINR. In other implementations, the UE 102 may report separate values of k_{max,x} for each TRS. The UE 102 may report the value of K_{tap,x} in CSI part 1 or CSI part 2. The value of K_{tap,x} may be the same for the X TRSs (e.g., K_{tap,x}=Kₜₐₚ). The UE 102 may report 1 value of Kₜₐₚ and

$$X {\sum }_{x = 1}^{X} {K}_{tap , x}$$

coefficients for the X TDCCs. The UE 102 may report the value of Kₜₐₚ in CSI part 1 and report

$$X {\sum }_{x = 1}^{X} {K}_{tap , x}$$

coefficients in CSI part 2. The payload size for the TDCC report in the CSI part 2 is based on the reported value of Kₜₐₚ in the CSI part 1. The value of K_{tap,x} may be different for each TRSs, such that the UE 102 reports all values of K_{tap,x} and

$$X {\sum }_{x = 1}^{X} {K}_{tap , x}$$

coefficients for the X TDCCs. The UE 102 may report the X values of K_{tap,x} in CSI part 1 and report the

$$X {\sum }_{x = 1}^{X} {K}_{tap , x}$$

coefficients in CSI part 2.

The UE 102 may reports the

$$X {\sum }_{x = 1}^{X} {K}_{tap , x}$$

coefficients, the value of Kₜₐₚ or X values of K_{tap,x}, the value of kₘₐₓ or X values of k_{max,x} for each symbol offset when the UE 102 reports the TDCC for more than 1 symbol offset. The UE 102 may report the

$$X {\sum }_{x = 1}^{X} {K}_{tap , x}$$

coefficients for each symbol offset, a common value of kₘₐₓ or X common values of k_{max,x}, and a common value of Kₜₐₚ or X common values of K_{tap,x} for the symbol offsets. In other implementations, the UE 102 reports the Kₜₐₚ coefficients and the value of kₘₐₓ for each symbol offset and a common value of Kₜₐₚ or X common values of K_{tap,x} for the symbol offsets. The UE 102 may also report the Kₜₐₚ coefficients and the value of Kₜₐₚ for each symbol offset and a common value of kₘₐₓ or X common values of k_{max,x} for the symbol offsets.

For each symbol offset for TRS x, the UE 102 may report the strongest K_{tap,x} taps. The UE 102 reports a first vector to indicate the index of the reported K_{tap,x} taps within the

$${K}_{tap}^{max}$$

as for each TRS and a second vector to indicate the coefficient for the reported K_{tap,x} taps for each TRS. The first vector may be a bitmap with

$$X {\sum }_{x = 1}^{X} {K}_{tap , x} bits ,$$

where the value “0” indicates that the tap is not reported and the value “1” indicates that the tap is reported. The value of K_{tap,x} may be the same for all of the TRSs, or the value of K_{tap,x} may be different for some of the TRSs. The UE 102 may also report the value of K_{tap,x}.

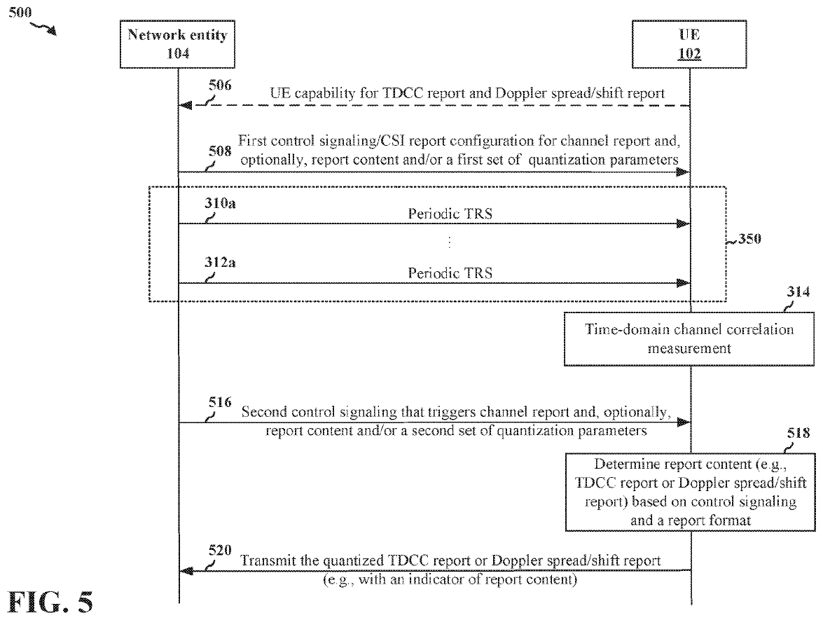

The UE 102 can report the first vector in CSI part 1 or CSI part 2. The UE 102 can also report the second vector in CSI part 1 or CSI part 2. In an example, the UE 102 reports the first vector in the CSI part 1 and reports the second vector the CSI part 2. The payload size of the second vector is based on the number of “1” values in the reported first vector. The UE 102 may additionally report a third vector in the CSI part 1 or the CSI part 2 indicating the value of K_{tap,x} for each TRS. The UE 102 may report the first/second vectors for each symbol offset when the UE 102 reports the TDCC for more than 1 symbol offset. In other implementations, the UE 102 reports the second vector for each symbol offset and a common first vector for all the symbol offsets. The third vector may be common or separate for the symbol offsets. FIGS. 3-4 describe TDCC reporting, whereas FIG. 5 describes Doppler spread/shift reporting.

FIG. 5 is a signaling diagram 500 that illustrates a report content selection procedure (e.g., a selection of TDCC report content or Doppler spread/shift report content). Elements 310a, 312a, 314, and 350 have already been described with respect to FIG. 3.

The UE 102 might be able to calculate a Doppler spread/shift based on the TDCC measurement 314. In such cases, the UE 102 can transmit 520 the Doppler spread/shift directly to the network entity 104 to reduce overhead. However, calculation of the Doppler spread/shift at the UE 102 may be of increased complexity and/or may consume an increased amount of time for the UE 102 to determine 518 the Doppler spread/shift based on one or more measurements 314 of the TDCC.

In addition to the UE capabilities that may be transmitted 306 to the network entity 104 for the TDCC report, the UE 102 may also transmit 506, to the network entity 104, a UE capability for Doppler spread/shift reporting. The UE capability report may indicate whether the UE 102 supports both Doppler spread/shift reporting and TDCC reporting or whether the UE 102 supports Doppler spread/shift reporting in lieu of TDCC reporting.

The network entity 104 transmits 508 first control signaling including a CSI report configuration to configure the UE 102 for a channel report. The first control signaling may optionally indicate the report content (e.g., TDCC report or Doppler spread/shift report) and/or a first set of quantization parameters. The network entity 104 transmits 516 second control signaling that triggers the channel report. The second control signaling may optionally indicate the report content (e.g., TDCC report or Doppler spread/shift report) and/or a second set of quantization parameters.

The UE 102 may determine 518 the report content (e.g., TDCC report or Doppler spread/shift report) and the report format. In examples, the UE 102 determines the report content based on the control signaling received 508, 516 from the network entity 104. The UE 102 transmits 520 the quantized TDCC report or the quantized Doppler spread/shift report to the network entity 104 based on the report content indicated in the control signaling. In other examples, the UE 102 may determine 518 the report content and the report format independent of the control signaling (e.g., based on the UE capability for Doppler spread/shift reporting and/or other parameters). The UE 102 transmits 520 the quantized TDCC report or the quantized Doppler spread/shift report to the network entity 104 with an indicator of the report content when the UE 102 determines 518 the report content independent of the control signaling.

If the UE 102 determines 518 to transmit a TDCC report to the network entity 104, the UE 102 quantizes the TDCC measurement 314 based on the first/second control signaling received 508, 516 the network entity 104 that indicates first/second quantization parameters. The UE 102 may also select third quantization parameters for determining 518 the TDCC report format for multiple TRSs. The UE 102 transmits 520 the TDCC report based on the quantized TDCC and the determined 518 TDCC report format. The TDCC report may include an indication that the report content corresponds to a TDCC report.

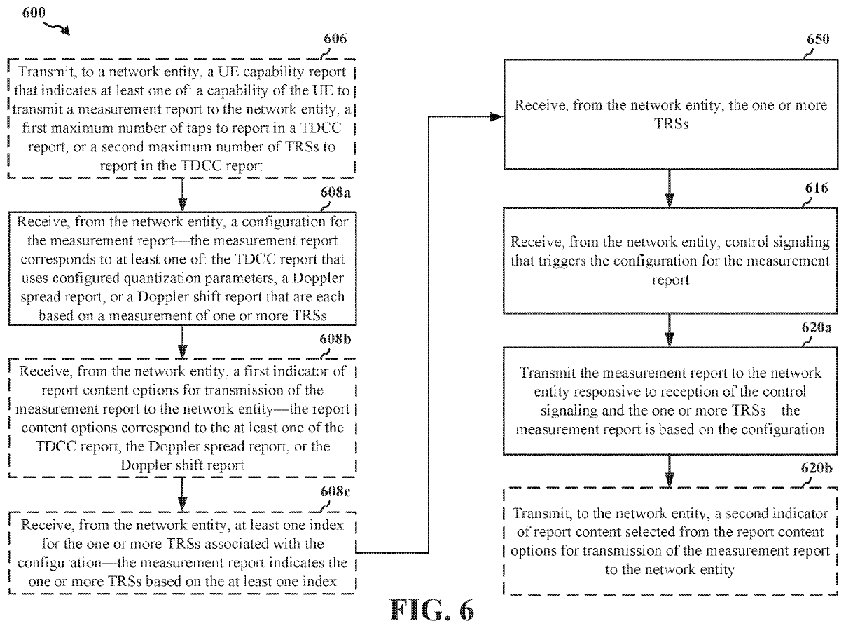

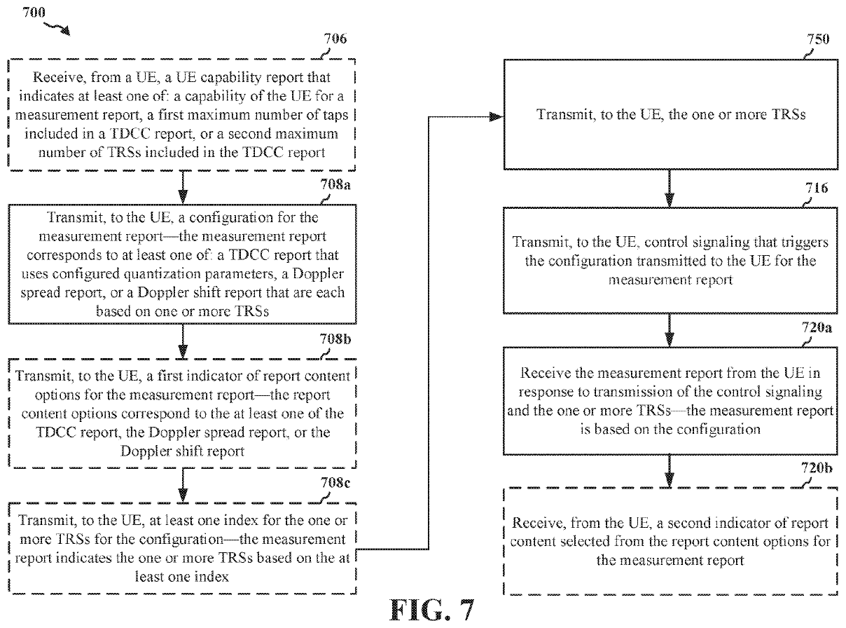

If the UE 102 determines 518 to transmit a Doppler spread/shift report to the network entity 104, the UE 102 may determine 518 the Doppler spread/shift based on the TDCC measurement 314. The UE 102 may also determine a report format for the Doppler spread/shift report. The UE 102 transmits 520 the Doppler spread/shift report to the network entity 104 based on the determined 518 Doppler spread/shift and report format. The Doppler spread/shift report may also include an indication that the report content corresponds to a Doppler spread/shift report. FIGS. 3-5 describe techniques for using one or more TRSs to report a quality of a channel. FIGS. 6-7 show methods for implementing one or more aspects of FIGS. 3-5. In particular, FIG. 6 shows an implementation by the UE 102 of the one or more aspects of FIGS. 3-5. FIG. 7 shows an implementation by the network entity 104 of the one or more aspects of FIGS. 3-5.

FIG. 6 illustrates a flowchart 600 of a method of wireless communication at a UE. With reference to FIGS. 1, 3-5, and 8, the method may be performed by the UE 102, the UE apparatus 802, etc., which may include the memory 826′, 806′, 816, and which may correspond to the entire UE 102 or the entire UE apparatus 802, or a component of the UE 102 or the UE apparatus 802, such as the wireless baseband processor 826 and/or the application processor 806.

The UE 102 transmits 606, to a network entity, a UE capability report that indicates at least one of: a capability of the UE to transmit a measurement report to the network entity, a first maximum number of taps to report in a TDCC report, or a second maximum number of TRSs to report in the TDCC report. For example, referring to FIGS. 3-4, the UE 102 transmits 306, to the network entity 104, a UE capability for a TDCC report. Referring to FIG. 5, the UE 102 can also transmit 506, to the network entity 104, a Doppler spread/shift report.

The UE 102 receives 608a, from the network entity, a configuration for the measurement report—the measurement report corresponds to at least one of: the TDCC report that uses configured quantization parameters, a Doppler spread report, or a Doppler shift report that are each based on a measurement of one or more TRSs. For example, referring to FIG. 3-4, the UE 102 receives 308, 408, from the network entity, first control signaling for a CSI report configuration. Referring to FIG. 5, the UE 102 receives 508, from the network entity 104, first control signaling for configuring a channel report, which may include a Doppler spread/shift report.

The UE 102 receives 608b, from the network entity, a first indicator of report content options for transmission of the measurement report to the network entity—the report content options correspond to the at least one of the TDCC report, the Doppler spread report, or the Doppler shift report. For example, referring to FIG. 5, the UE 102 receives 508, from the network entity 104, first control signaling that may indicate report content for a channel report, where the report content can correspond to a TDCC report or a Doppler spread/shift report.

The UE 102 receives 608c, from the network entity, at least one index for the one or more TRSs associated with the configuration—the measurement report indicates the one or more TRSs based on the at least one index. For example, referring to FIGS. 3-5, the first control signaling that the UE 102 receives 308, 408, 508 from the network entity 104 can indicate one or more indexes for the one or more TRSs.

The UE 102 receives 650, from the network entity, the one or more TRSs. For example, referring to FIGS. 3 and 5, the UE 102 receives 350, from the network entity 104 one or more periodic TRSs based on a per-TRS transmission procedure. Referring to FIG. 4, the UE receives 450a, 450b, from the network entity 104, one or more periodic TRSs based on cross-TRS transmission procedures.

The UE 102 receives 616, from the network entity, control signaling that triggers the configuration for the measurement report. For example, referring to FIGS. 3-4, the UE 102 receives 316, 416, from the network entity 104, second control signaling that triggers the TDCC report. Referring to FIG. 5, the UE 102 receives 516, from the network entity 104, second control signaling that triggers a channel report, where the channel report can correspond to a TDCC report or a Doppler spread/shift report.

The UE 102 transmits 620a the measurement report to the network entity responsive to reception of the control signaling and the one or more TRSs—the measurement report is based on the configuration. For example, referring to FIGS. 3-4, the UE 102 transmits 320, 420, to the network entity 104, a quantized TDCC report responsive to the second control signaling and the periodic TRSs. Referring to FIG. 5, the UE 102 can also transmit 520, to the network entity 104, a Doppler spread/shift report responsive to the second control signaling and the periodic TRSs.

The UE 102 transmits 620b, to the network entity, a second indicator of report content selected from the report content options for transmission of the measurement report to the network entity. For example, referring to FIG. 5, the UE 102 transmits 520, to the network entity 104, an indicator of the report content (e.g., TDCC report or Doppler spread/shift report) with the channel report. FIG. 6 describes a method from a UE-side of a wireless communication link, whereas FIG. 7 describes a method from a network-side of the wireless communication link.

FIG. 7 is a flowchart 700 of a method of wireless communication at a network entity. With reference to FIGS. 1, 3-5, and 9, the method may be performed by one or more network entities 104, which may correspond to a base station or a unit of the base station, such as the RU 106, the DU 108, the CU 110, an RU processor 906, a DU processor 926, a CU processor 946, etc. The one or more network entities 104 may include memory 906/926/946′, which may correspond to an entirety of the one or more network entities 104, or a component of the one or more network entities 104, such as the RU processor 906, the DU processor 926, or the CU processor 946.

The network entity 104 receives 706, from a UE, a UE capability report that indicates at least one of: a capability of the UE for a measurement report, a first maximum number of taps included in a TDCC report, or a second maximum number of TRSs included in the TDCC report. For example, referring to FIGS. 3-4, the network entity 102 receives 306, from the UE 102, a UE capability for a TDCC report. Referring to FIG. 5, the network entity 104 can also receive 506, from the UE 102, a Doppler spread/shift report.

The network entity 104 transmits 708a, to the UE, a configuration for the measurement report—the measurement report corresponds to at least one of: a TDCC report that uses configured quantization parameters, a Doppler spread report, or a Doppler shift report that are each based on one or more TRSs. For example, referring to FIG. 3-4, the network entity 104 transmits 308, 408, to the UE 102, first control signaling for a CSI report configuration. Referring to FIG. 5, the network entity 104 transmits 508, to the UE 102, first control signaling for configuring a channel report, which may include a Doppler spread/shift report.

The network entity 104 transmits 708b, to the UE, a first indicator of report content options for the measurement report—the report content options correspond to the at least one of the TDCC report, the Doppler spread report, or the Doppler shift report. For example, referring to FIG. 5, the network entity 104 transmits 508, to the UE 102, first control signaling that may indicate report content for a channel report, where the report content can correspond to a TDCC report or a Doppler spread/shift report.

The network entity 104 transmits 708c, to the UE, at least one index for the one or more TRSs for the configuration—the measurement report indicates the one or more TRSs based on the at least one index. For example, referring to FIGS. 3-5, the first control signaling that the network entity 104 transmits 308, 408, 508 to the UE 102 can indicate one or more indexes for the one or more TRSs.

The network entity 104 transmits 750, to the UE, the one or more TRSs. For example, referring to FIGS. 3 and 5, the network entity 104 transmits 350, to the UE 102 one or more periodic TRSs based on a per-TRS transmission procedure. Referring to FIG. 4, the network entity 104 transmits 450a, 450b, to the UE 102, one or more periodic TRSs based on cross-TRS transmission procedures.

The network entity 104 transmits 716, to the UE, control signaling that triggers the configuration transmitted to the UE for the measurement report. For example, referring to FIGS. 3-4, the network entity 104 transmits 316, 416, to the UE 102, second control signaling that triggers the TDCC report. Referring to FIG. 5, the network entity 104 transmits 516, to the UE 102, second control signaling that triggers a channel report, where the channel report can correspond to a TDCC report or a Doppler spread/shift report.

The network entity 104 receives 720a the measurement report from the UE in response to transmission of the control signaling and the one or more TRSs—the measurement report is based on the configuration. For example, referring to FIGS. 3-4, the network entity 104 receives 320, 420, from the UE 102, a quantized TDCC report responsive to the second control signaling and the periodic TRSs. Referring to FIG. 5, the network entity 104 can also receive 520, from the UE 102, a Doppler spread/shift report responsive to the second control signaling and the periodic TRSs.

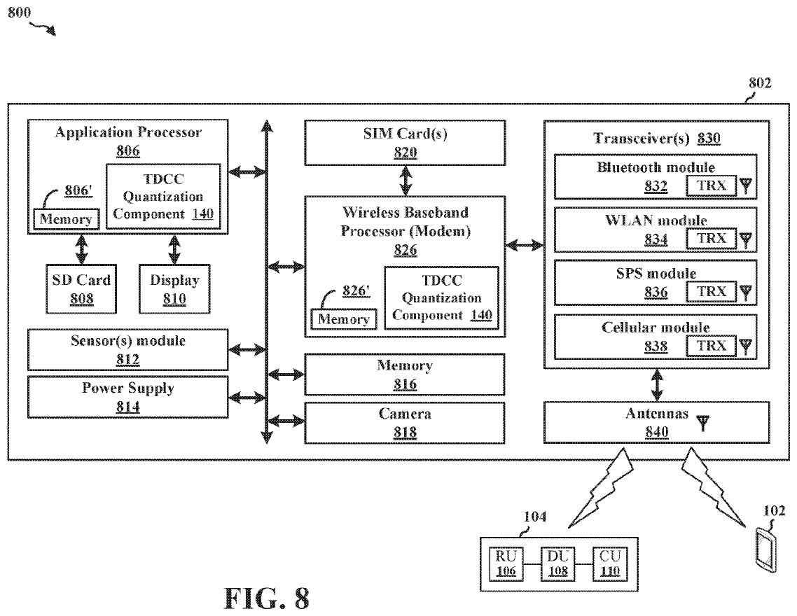

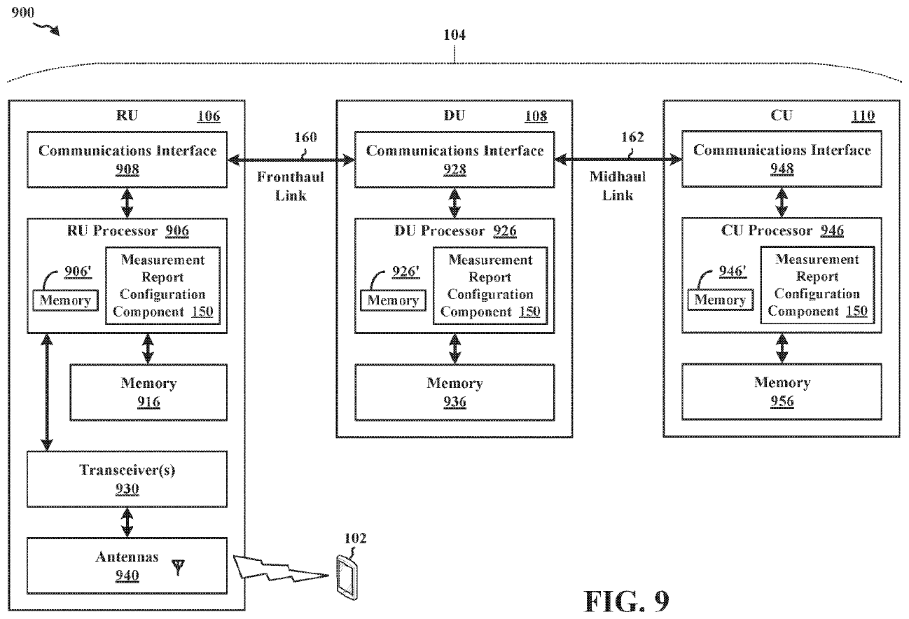

The network entity 104 receives 720b, from the UE, a second indicator of report content selected from the report content options for the measurement report. For example, referring to FIG. 5, the network entity 104 receives 520, from the UE 102, an indicator of the report content (e.g., TDCC report or Doppler spread/shift report) with the channel report. A UE apparatus 802, as described in FIG. 8, may perform the method of flowchart 600. The one or more network entities 104, as described in FIG. 9, may perform the method of flowchart 700.

FIG. 8 is a diagram 800 illustrating an example of a hardware implementation for a UE apparatus 802. The UE apparatus 802 may be the UE 102, a component of the UE 102, or may implement UE functionality. The UE apparatus 802 may include an application processor 806, which may have on-chip memory 806′. In examples, the application processor 806 may be coupled to a secure digital (SD) card 808 and/or a display 810. The application processor 806 may also be coupled to a sensor(s)module 812, a power supply 814, an additional module of memory 816, a camera 818, and/or other related components. For example, the sensor(s) module 812 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 802 may further include a wireless baseband processor 826, which may be referred to as a modem. The wireless baseband processor 826 may have on-chip memory 826′. Along with, and similar to, the application processor 806, the wireless baseband processor 826 may also be coupled to the sensor(s) module 812, the power supply 814, the additional module of memory 816, the camera 818, and/or other related components. The wireless baseband processor 826 may be additionally coupled to one or more subscriber identity module (SIM) card(s) 820 and/or one or more transceivers 830 (e.g., wireless RF transceivers).

Within the one or more transceivers 830, the UE apparatus 802 may include a Bluetooth module 832, a WLAN module 834, an SPS module 836 (e.g., GNSS module), and/or a cellular module 838. The Bluetooth module 832, the WLAN module 834, the SPS module 836, and the cellular module 838 may each include an on-chip transceiver (TRX), or in some cases, just a transmitter (TX) or just a receiver (RX). The Bluetooth module 832, the WLAN module 834, the SPS module 836, and the cellular module 838 may each include dedicated antennas and/or utilize antennas 840 for communication with one or more other nodes. For example, the UE apparatus 802 can communicate through the transceiver(s) 830 via the antennas 840 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 826 and the application processor 806 may each include a computer-readable medium/memory 826′, 806′, respectively. The additional module of memory 816 may also be considered a computer-readable medium/memory. Each computer-readable medium/memory 826′, 806′, 816 may be non-transitory. The wireless baseband processor 826 and the application processor 806 may each be responsible for general processing, including execution of software stored on the computer-readable medium/memory 826′, 806′, 816. The software, when executed by the wireless baseband processor 826/application processor 806, causes the wireless baseband processor 826/application processor 806 to perform the various functions described herein. The computer-readable medium/memory may also be used for storing data that is manipulated by the wireless baseband processor 826/application processor 806 when executing the software. The wireless baseband processor 826/application processor 806 may be a component of the UE 102. The UE apparatus 802 may be a processor chip (e.g., modem and/or application) and include just the wireless baseband processor 826 and/or the application processor 806. In other examples, the UE apparatus 802 may be the entire UE 102 and include the additional modules of the apparatus 802.

As discussed, the TDCC quantization component 140 is configured to receive, from a network entity, a configuration for a measurement report, the measurement report comprising at least one of: a TDCC report using configured quantization parameters, a Doppler spread report, or a Doppler shift report that are each based on a measurement of one or more TRSs; receive, from the network entity, the one or more TRSs; receive, from the network entity, control signaling that triggers the configuration for the measurement report; and transmit the measurement report to the network entity responsive to the receiving the control signaling and the one or more TRSs, the measurement report based on the configuration. The TDCC quantization component 140 may be within the wireless baseband processor 826, the application processor 806, or both the wireless baseband processor 826 and the application processor 806. The TDCC quantization component 140 may be one or more hardware components specifically configured to carry out the stated processes/algorithm, implemented by one or more processors configured to perform the stated processes/algorithm, stored within a computer-readable medium for implementation by the one or more processors, or a combination thereof.

The UE apparatus 802 may include a variety of components configured for various functions. In examples, the UE apparatus 802, and in particular the wireless baseband processor 826 and/or the application processor 806, includes means for receiving, from a network entity, a configuration for a measurement report, the measurement report comprising at least one of: a TDCC report using configured quantization parameters, a Doppler spread report, or a Doppler shift report that are each based on a measurement of one or more TRSs; means for receiving, from the network entity, the one or more TRSs; means for receiving, from the network entity, control signaling that triggers the configuration for the measurement report; and means for transmitting the measurement report to the network entity responsive to the receiving the control signaling and the one or more TRSs, the measurement report based on the configuration. The UE apparatus 802 further includes means for transmitting, to the network entity, a UE capability report that indicates at least one of: a capability of the UE to transmit the measurement report to the network entity, a first maximum number of taps to report in the TDCC report, or a second maximum number of TRSs to report in the TDCC report, the second maximum number of TRSs being communicated at least one of: within a serving cell or across serving cells. The UE apparatus 802 further includes means for receiving, from the network entity, at least one index for the one or more TRSs associated with the configuration, where the measurement report indicates the one or more TRSs based on the at least one index. The UE apparatus 802 further includes means for receiving, from the network entity, a second indication of report content options for the transmitting the measurement report to the network entity, the report content options corresponding to the at least one of the TDCC report, the Doppler spread report, or the Doppler shift report; and means for transmitting, to the network entity, a third indication of report content selected from the report content options for the transmitting the measurement report to the network entity. The means may be the TDCC quantization component 140 of the UE apparatus 802 configured to perform the functions recited by the means.

FIG. 9 is a diagram 900 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 946, which may have on-chip memory 946′. In some aspects, the CU 110 may further include an additional module of memory 956 and/or a communications interface 948, both of which may be coupled to the CU processor 946. The CU 110 can communicate with the DU 108 through a midhaul link 162, such as an F1 interface between the communications interface 948 of the CU 110 and a communications interface 928 of the DU 108.

The DU 108 may include a DU processor 926, which may have on-chip memory 926′. In some aspects, the DU 108 may further include an additional module of memory 936 and/or the communications interface 928, both of which may be coupled to the DU processor 926. The DU 108 can communicate with the RU 106 through a fronthaul link 160 between the communications interface 928 of the DU 108 and a communications interface 908 of the RU 106.

The RU 106 may include an RU processor 906, which may have on-chip memory 906′. In some aspects, the RU 106 may further include an additional module of memory 916, the communications interface 908, and one or more transceivers 930, all of which may be coupled to the RU processor 906. The RU 106 may further include antennas 940, which may be coupled to the one or more transceivers 930, such that the RU 106 can communicate through the one or more transceivers 930 via the antennas 940 with the UE 102.

The on-chip memory 906′, 926′, 946′ and the additional modules of memory 916, 936, 956 may each be considered a computer-readable medium/memory. Each computer-readable medium/memory may be non-transitory. Each of the processors 906, 926, 946 is responsible for general processing, including execution of software stored on the computer-readable medium/memory. The software, when executed by the corresponding processor(s) 906, 926, 946 causes the processor(s) 906, 926, 946 to perform the various functions described herein. The computer-readable medium/memory may also be used for storing data that is manipulated by the processor(s) 906, 926, 946 when executing the software. In examples, the measurement report configuration component 150 may sit at the one or more network entities 104, such as at the CU 110; both the CU 110 and the DU 108; each of the CU 110, the DU 108, and the RU 106; the DU 108; both the DU 108 and the RU 106; or the RU 106.

As discussed, the measurement report configuration component 150 is configured to transmit, to a UE, a configuration for a measurement report, the measurement report comprising at least one of: a TDCC report using configured quantization parameters, a Doppler spread report, or a Doppler shift report that are each based on TRSs; transmit, to the UE, the one or more TRSs; transmit, to the UE, control signaling that triggers the configuration transmitted to the UE for the measurement report; and receive the measurement report from the UE in response to the transmitting the control signaling and the one or more TRSs, the measurement report based on the configuration. The measurement report configuration component 150 may be within one or more processors of the one or more network entities 104, such as the RU processor 906, the DU processor 926, and/or the CU processor 946. The measurement report configuration component 150 may be one or more hardware components specifically configured to carry out the stated processes/algorithm, implemented by one or more processors 906, 926, 946 configured to perform the stated processes/algorithm, stored within a computer-readable medium for implementation by the one or more processors 906, 926, 946, or a combination thereof.

The one or more network entities 104 may include a variety of components configured for various functions. In examples, the one or more network entities 104 include means for transmitting, to a UE, a configuration for a measurement report, the measurement report comprising at least one of: a TDCC report using configured quantization parameters, a Doppler spread report, or a Doppler shift report that are each based on one or more TRSs; means for transmitting, to the UE, the one or more TRSs; means for transmitting, to the UE, control signaling that triggers the configuration transmitted to the UE for the measurement report; and means for receiving the measurement report from the UE in response to the transmitting the control signaling and the one or more TRSs, the measurement report based on the configuration. The one or more network entities 104 further include means for receiving, from the UE, a UE capability report that indicates at least one of: a capability of the UE for the measurement report, a first maximum number of taps included in the TDCC report, or a second maximum number of TRSs included in the TDCC report, the second maximum number of TRSs being communicated at least one of within a serving cell or across serving cells. The one or more network entities 104 further include means for transmitting, to the UE, at least one index for the one or more TRSs for the configuration, where the measurement report indicates the one or more TRSs based on the at least one index. The one or more network entities 104 further include means for transmitting, to the UE, a second indication of report content options for the measurement report, the report content options corresponding to the at least one of the TDCC report, the Doppler spread report, or the Doppler shift report; and means for receiving, from the UE, a third indication of report content selected from the report content options for the measurement report. The means may be the measurement report configuration component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A. B, or C” include any combination of A, B, and/or C, such as A and B, A and C. B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A” where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a configuration for a measurement report, the measurement report including at least one of: a TDCC report using configured quantization parameters, a Doppler spread report, or a Doppler shift report that are each based on a measurement of one or more TRSs; receiving, from the network entity, the one or more TRSs; receiving, from the network entity, control signaling that triggers the configuration for the measurement report; and transmitting the measurement report to the network entity responsive to the receiving the control signaling and the one or more TRSs, the measurement report based on the configuration.

Example 2 may be combined with example 1 and further includes transmitting, to the network entity, a UE capability report that indicates at least one of: a capability of the UE to transmit the measurement report to the network entity, a first maximum number of taps to report in the TDCC report, or a second maximum number of TRSs to report in the TDCC report, the second maximum number corresponding to first TRSs associated with a serving cell or second TRSs associated with a different cell than the serving cell.

Example 3 may be combined with any of examples 1-2 and includes that the configuration corresponds to at least one of: a first set of TDCC quantization parameters indicated in the configuration, a second set of TDCC quantization parameters indicated in the control signaling, or a third set of TDCC quantization parameters determined at the UE and included in the measurement report.

Example 4 may be combined with any of examples 1-3 and includes that the configuration includes a first indication of at least one of: a first maximum number of taps to report in the TDCC report, a second maximum number of TRSs to report in the TDCC report, a third maximum number of taps to measure for each TRS of the one or more TRSs, a fourth maximum number of taps to report for each TRS in the TDCC report, a first number of taps to report in the TDCC report, a second number of taps to report for each TRS in the TDCC report, a time-domain duration of each tap for each TRS, a third number of bits for quantized NZCs for each TRS, quantized content for each NZC, a fourth number of TDCCs to report in the TDCC report, or a symbol offset for the TDCC report.

Example 5 may be combined with example 4 and includes that the TDCC report indicates an applied parameter from the configuration.

Example 6 may be combined with any of examples 1-5 and includes that the TDCC report indicates at least one of: a first strongest set of taps, a second strongest set of taps after the first strongest set of taps, an adjacent set of taps to the first strongest set of taps, or a set of taps associated with at least one of a strongest L1-RSRP or a strongest L I-SINR.

Example 7 may be combined with example 6 and includes that the TDCC report indicates taps based on a tap strength index.

Example 8 may be combined with any of examples 1-7 and includes that the TDCC report indicates at least one of an amplitude or a phase of a TDCC coefficient for each tap reported in the TDCC report.

Example 9 may be combined with any of examples 1-2 and further includes receiving, from the network entity, at least one index for the one or more TRSs associated with the configuration, where the measurement report indicates the one or more TRSs based on the at least one index.

Example 10 may be combined with any of examples 1-9 and further includes receiving, from the network entity, a second indication of report content options for the transmitting the measurement report to the network entity, the report content options corresponding to the at least one of the TDCC report, the Doppler spread report, or the Doppler shift report; and transmitting, to the network entity, a third indication of report content selected from the report content options for the transmitting the measurement report to the network entity.

Example 11 may be combined with any of examples 1-10 and further includes measuring TDCC for the measurement report based on at least one of an L1-RSRP or an L1-SINR for at least one receiving antenna port of the UE, where the TDCC for the measurement report corresponds to: a single TDCC associated with all TDCCs measured for the measurement report, or a plurality of TDCC associated with each TDCC measured for the measurement report.

Example 12 is a method of wireless communication at a network entity, including: transmitting, to a UE, a configuration for a measurement report, the measurement report including at least one of: a TDCC report using configured quantization parameters, a Doppler spread report, or a Doppler shift report that are each based on one or more TRSs; transmitting, to the UE, the one or more TRSs; transmitting, to the UE, control signaling that triggers the configuration transmitted to the UE for the measurement report; and receiving the measurement report from the UE in response to the transmitting the control signaling and the one or more TRSs, the measurement report based on the configuration.

Example 13 may be combined with example 12 and further includes receiving, from the UE, a UE capability report that indicates at least one of: a capability of the UE for the measurement report, a first maximum number of taps included in the TDCC report, or a second maximum number of TRSs included in the TDCC report, the second maximum number corresponding to first TRSs associated with a serving cell or second TRSs associated with a different cell than the serving cell.

Example 14 may be combined with any of examples 12-13 and includes that the configuration corresponds to at least one of: a first set of TDCC quantization parameters indicated in the configuration, a second set of TDCC quantization parameters indicated in the control signaling, or a third set of TDCC quantization parameters included in the measurement report.

Example 15 may be combined with any of examples 12-14 and includes that the configuration includes a first indication of at least one of: a first maximum number of taps included in the TDCC report, a second maximum number of TRSs included in the TDCC report, a third maximum number of taps for each TRS, a fourth maximum number of taps for each TRS in the TDCC report, a first number of taps included in the TDCC report, a second number of taps for each TRS in the TDCC report, a time-domain duration of each tap for each TRS, a third number of bits for quantized NZCs for each TRS, quantized content for each NZC, a fourth number of TDCCs included in the TDCC report, or a symbol offset for the TDCC report.

Example 16 may be combined with example 15 and includes that the TDCC report indicates at least one of: a first strongest set of taps, a second strongest set of taps after the first strongest set of taps, an adjacent set of taps to the first strongest set of taps, or a set of taps associated with at least one of a strongest L1-RSRP or a strongest L1-SINR.

Example 17 may be combined with any of examples 15-16 and includes that the TDCC report indicates at least one of an amplitude or a phase of a TDCC coefficient for each tap included the TDCC report.

Example 18 may be combined with any of examples 12-17 and further includes transmitting, to the UE, at least one index for the one or more TRSs for the configuration, where the measurement report indicates the one or more TRSs based on the at least one index.

Example 19 may be combined with any of examples 12-18 and further includes transmitting, to the UE, a second indication of report content options for the measurement report, the report content options corresponding to the at least one of the TDCC report, the Doppler spread report, or the Doppler shift report; and receiving, from the UE, a third indication of report content selected from the report content options for the measurement report.

Example 20 is an apparatus for wireless communication for implementing a method as in any of examples 1-19.

Example 21 is an apparatus for wireless communication including means for implementing a method as in any of examples 1-19.

Example 22 is a non-transitory computer-readable medium storing computer executable code, the code when executed by a processor causes the processor to implement a method as in any of examples 1-19.

1. A method of wireless communication at a user equipment (UE), comprising:
receiving, from a network entity, a configuration for a measurement report, the measurement report comprising a time domain channel correlation (TDCC) report using configured quantization parameters based on a measurement of one or more tracking reference signals (TRSs);
receiving, from the network entity, the one or more TRSs; and
transmitting, to the network entity responsive to the receiving the one or more TRSs, the measurement report based on the configuration.

2. The method of claim 1, further comprising:
receiving, from the network entity, control signaling that triggers the configuration for the measurement report.

3. The method of claim 1, further comprising:
measuring TDCC for the measurement report based on at least one of a layer 1 reference signal received power (L1-RSRP) or a layer 1 signal-to-interference plus noise ratio (L1-SINR) for at least one receiving antenna port of the UE, wherein the TDCC for the measurement report corresponds to:
a single TDCC associated with all TDCCs measured for the measurement report, or
a plurality of TDCCs associated with each TDCC measured for the measurement report.

4. The method of claim 1, further comprising:
transmitting, to the network entity, a UE capability report that indicates at least one of:
a capability of the UE for TDCC reporting, or
a maximum number of TRSs to report in the TDCC report.

5. The method of claim 1, wherein the configuration corresponds to at least one of:
a first set of TDCC quantization parameters indicated in the configuration,
a second set of TDCC quantization parameters indicated in control signaling, or
a third set of TDCC quantization parameters determined at the UE and included in the measurement report.

6. The method of claim 1, wherein the configuration configures the UE to at least one of:
report the TDCC report based on at least one of: intra-slot TDCC, inter-slot TDCC, or both intra-slot TDCC and inter-slot TDCC,
perform amplitude-only reporting or both amplitude and phase reporting for the TDCC report, or
report a number of TDCCs in the TDCC report.

7. The method of claim 1, wherein the TDCC report is included in a channel state information (CSI) part 1.

8. The method of claim 1, wherein the TDCC report indicates at least one of:
a first strongest set of taps,
a second strongest set of taps after the first strongest set of taps,
an adjacent set of taps to the first strongest set of taps, or
a set of taps associated with at least one of a strongest layer 1 reference signal received power (L1-RSRP) or a strongest layer 1 signal-to-interference plus noise ratio (L1-SINR).

9. (canceled)

10. The method of claim 1, wherein the TDCC report indicates at least one of an amplitude-only or both an amplitude and a phase of a TDCC reported in the TDCC report.

11. The method of claim 1, further comprising:
receiving, from the network entity, at least one index for the one or more TRSs associated with the configuration, wherein the measurement report indicates the one or more TRSs based on the at least one index.

12. (canceled)

13. A method of wireless communication at a network entity, comprising:
transmitting, to a user equipment (UE), a configuration for a measurement report, the measurement report comprising a time domain channel correlation (TDCC) report using configured quantization parameters based on one or more tracking reference signals (TRSs);
transmitting, to the UE, the one or more TRSs; and
receiving, from the UE in response to the transmitting the one or more TRSs, the measurement report based on the configuration.

14. The method of claim 13, further comprising:
receiving, from the UE, a UE capability report that indicates at least one of:
a capability of the UE for TDCC reporting, or
a maximum number of TRSs to report in the TDCC report.

15. An apparatus for wireless communication at a user equipment (UE), comprising:
a transceiver,
a memory; and
a processor coupled to the memory and the transceiver, the processor configured to:
receive, from a network entity, a configuration for a measurement report, the measurement report comprising a time domain channel correlation (TDCC) report using configured quantization parameters, based on a measurement of one or more tracking reference signals (TRSs);
receive, from the network entity, the one or more TRSs; and
transmit, to the network entity responsive to the receiving the one or more TRSs, the measurement report based on the configuration.

16. The method of claim 1, wherein the configured quantized parameters of the configuration include a 3-bit quantization for the amplitude reporting and a 3-bit quantization for the phase reporting.

17. The method of claim 12, wherein the TDCC report indicates at least one of an amplitude-only or both an amplitude and a phase of a TDCC reported in the TDCC report.

18. The apparatus of claim 15, wherein the processor is configured to:
transmit, to the network entity, a UE capability report that indicates at least one of:
a capability of the UE for TDCC reporting, or
a maximum number of TRSs to report in the TDCC report.

19. The apparatus of claim 15, wherein the TDCC report indicates at least one of an amplitude-only or both an amplitude and a phase of a TDCC reported in the TDCC report.

20. The apparatus of claim 15, wherein the configuration configures the UE to at least one of:
report the TDCC report based on at least one of: intra-slot TDCC, inter-slot TDCC, or both intra-slot TDCC and inter-slot TDCC,
perform amplitude-only reporting or both amplitude and phase reporting for the TDCC report, or
report a number of TDCCS in the TDCC report.

21. The method of claim 15, wherein the configured quantized parameters of the configuration include a 3-bit quantization for the amplitude reporting and a 3-bit quantization for the phase reporting.

22. The apparatus of claim 19, wherein the TDCC report is included in a channel state information (CSI) part 1.
